(19) United States
(12) Patent Application Publication
(10) Pub. No.: US 2023/0116131 A1
(43) Pub. Date: Apr. 13, 2023

(54) USE OF AN ALKYL METHACRYLATE POLYMER TO REDUCE PARTICULATE EMISSIONS

(71) Applicant: TotalEnergies OneTech, COURBEVOIE (FR)

(72) Inventors: Gautier BURETTE, SOLAIZE (FR); François PAOLONI, SOLAIZE (FR)

(73) Assignee: TotalEnergies OneTech, COURBEVOIE (FR)

(21) Appl. No.: 17/913,702

(22) PCT Filed: Mar. 23, 2021
(86) PCT No.: PCT/EP2021/057415

§ 371 Date: Sep. 22, 2022

(30) Foreign Application Priority Data
Mar. 25, 2020 (FR) FR2002904

(51) Int. Cl. C08L 91/00

(52) U.S. Cl. CPC C08L 91/00

(57) ABSTRACT

The present invention relates to the use of lubricant composition containing a base oil and at least one alkyl methacrylate polymer, to reduce engine particulate emissions.

### CROSS REFERENCE TO RELATED APPLICATIONS

The present application is a U.S. National Phase Application under 35 U.S.C. § 371 of International Patent Application No. PCT/EP2021/057415 filed Mar. 23, 2021, which claims priority of French Patent Application No. 20 02904 filed Mar. 25, 2020. The entire contents of which are hereby incorporated by reference.

### FIELD OF THE INVENTION

The present invention relates to the use of an alkyl methacrylate polymer for reducing particle emissions from motor vehicles.

### BACKGROUND

The first European standard on emissions from vehicles with combustion engines was introduced in 1992. Coming into force on 1 Sep. 2014 for newly approved vehicles and applicable to all new vehicles from 1 Sep. 2015, the Euro 6 emission standard (EC standard 715/2007, amendment 692/2008) relates to both gasoline and diesel engines. This standard in particular concerns four pollutants: carbon monoxide (CO), unburned hydrocarbons (HC), nitrogen oxides (NOx), mass (PM) and number (PN) of particles, amongst which soot, the last two remaining the most problematic for the pollution control system of modern engines.

Subsequent standards provided for reductions in the number and weight of particles to much more drastic levels, more particularly the particle size (directly related to the weight and the number) to values less than 23 nm.

Tackling CO₂ prompted manufacturers to increase the efficiency thereof so as to lower the consumption of CO₂. To this end, a lean-burn operation (air in excess compared to the weight of fuel) was often chosen. Unfortunately, such a process generates a significant increase in the emissions of nitrogen oxide and particles.

In the past, manufacturers have also chosen to introduce particle filter systems for reducing the number and weight of particles emitted into the atmosphere. In most cases, the operation of such systems consists of the combustion of soot due to the temperature rise of the exhaust gases at the inlet of the filter. Such operation requires the presence of catalysis.

Further finding additives for lubricating compositions and lubricating compositions with direct impact on the emission of particles, would be an advantage.

### SUMMARY

A goal of the present invention is thus to provide an additive for a lubricating composition with direct impact on particle emissions.

Another goal of the present invention is to provide a lubricating composition with direct impact on particle emissions.

Further goals will emerge upon reading the following description of the invention.

Such goals are fulfilled by the present application, which relates to the use of a lubricating composition comprising a base oil and at least one alkyl methacrylate polymer, for reducing particle emissions from an engine.

In the context of the present invention, the term “particles” refers to the particles emitted by the exhaust of motor vehicles. It means a family of microscopic particles (about μm or less in size). Such substances are varied and are comprised in the vehicle exhaust gases coming from the combustion of fuel. Such substances can be either solid or liquid. The term particles comprises the term soot, which is formed, is oxidized and contains unburned hydrocarbons, oxygenated derivatives (ketones, esters, aldehydes, lactones, ethers, organic acids) and polycyclic aromatic hydrocarbons (the famous PAHs) along with the nitrated, oxygenated derivatives thereof, etc. Furthermore, there are also mineral (SO2, sulphates, etc.) and metal derivatives.

In a particularly advantageous manner, the present invention can be used for reducing the emissions of particles with a size less than or equal to 23 nm.

Within the framework of the present invention, the term “particle size” refers to particles, or agglomerate of particles the size of which is comprised between 0.001 and 23 nm, preferentially between 0.01 and 23 nm, and more preferentially between 0.1 and 23 nm.

The size of the particles can in particular be measured by spectrometry, e.g. using a spectrometer manufactured by Cambustion under the commercial reference DMS500.

Reduction of particle emissions refers, in particular, to the reduction of the number of particles, in particular of particles having a size less than or equal to 23 nm. Reducing the number of particles emitted during a WLTC cycle is discussed, in particular. The reduction is mainly determined as a function of the number of kilometers traveled.

The number of particles can in particular, be measured by a particle counter device such as the device existing under the commercial reference AVL APC 489.

Preferentially, the present application relates to the reduction of soot emission.

Preferentially, the present invention relates to the reduction of the emission of particles, preferentially particles of size less than or equal to 23 nm, preferentially soot, during the urban (low speed), peri-urban (moderate speed) and road (high speed) cycles defined by the WLTC (or WLTP) (Worldwide Harmonized Light vehicle Test Procedure) and across all WLTC.

The alkyl methacrylate polymer is a comb polymer the pendant chains of which comprise at least 50 carbon atoms and chosen from copolymers of at least one polyolefin and of at least one poly(alkyl)methacrylate; copolymers of at least one polyolefin and of at least one poly(alkyl)acrylate.

Preferentially, the alkyl methacrylate polymer is a comb polymer the pendant chains of which are obtained by polymerization or copolymerization of olefins, preferentially olefins comprising from 8 to 17 carbon atoms and chosen from styrenes, substituted styrenes, butadiene with 1,4-addition, butadiene with 1,2-addition, compounds with the formula (C1)

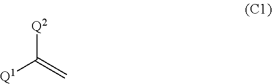

wherein Q¹ and Q² independently represent a hydrogen atom or a C₁-C₁₈-alkyl group.

Advantageously, the alkyl methacrylate polymer is prepared by copolymerization: of an olefinic monomer with the formula (C2)

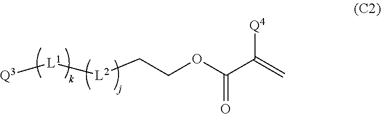

wherein
Q³ represents a linear or branched C₂-C₈-alkyl group; a C₃-C₃-cycloalkyl group;
a C₅-C₁₀-aryl group;
Q⁴ represents a hydrogen atom or a methyl group;
L¹ represents a 1,4-addition residue of butadiene; a 1,4-addition residue of butadiene substituted with at least one C₁-C₆ alkyl group; a vinyl addition residue of styrene; a vinyl addition residue of styrene substituted with at least one C₁-C₆-alkyl group;
L² represents a vinyl addition residue of butadiene; a vinyl addition residue of butadiene substituted with a C-Cc-alkyl group; a vinyl addition residue of styrene; a vinyl addition residue of styrene substituted with at least one C₁-C₆-alkyl group;
k and j independently represent 0 or an integer ranging from 1 to 3,000, and the sum (k+j) is equal to an integer ranging from 7 to 3,000, preferentially ranging from 10 to 3,000; and of an acrylic alkyl ester or methacrylic alkyl ester monomer with the formula (C3)

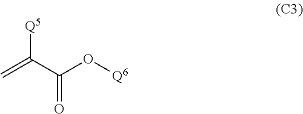

Wherein:
Q⁵ represents a hydrogen atom or a methyl group
Q⁶ represents an either linear or branched C₁-C₂₆ alkyl group

Even more advantageously, the alkyl methacrylate polymer is prepared by copolymerization:
of an olefinic monomer with the formula (C4)

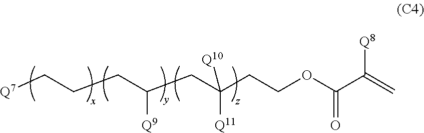

wherein:
Q⁷ represents a C₁-C₆-alkyl group; a C₆-aryl group;
Q⁸ represents a hydrogen atom or a methyl group;
Q⁹, Q¹⁰ and Q¹¹ independently represent a hydrogen atom or a C₁-C₁₈-alkyl group;
x, y and z independently represent 0 or an integer ranging from 1 to 3,000 and the sum (x+y+z) is equal to an integer ranging from 7 to 3,000, preferentially ranging from 10 to 3,000; and of an acrylic alkyl ester or methacrylic alkyl ester monomer with the formula (C3)

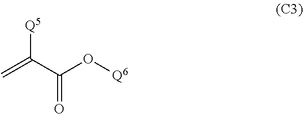

wherein:
Q⁵ represents a hydrogen atom or a methyl group;
Q⁶ represents an either linear or branched C₁-C₂₆ alkyl group.

More preferentially, Q⁷ represents a phenyl group or an either linear or branched butyl group, in particular an n-butyl group.

More particularly preferred, the comb polymer is prepared by copolymerization: of an olefinic monomer with the formula (C5)

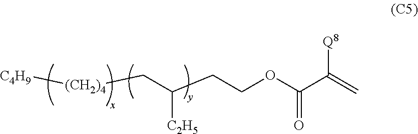

wherein
Q¹ represents a hydrogen atom or a methyl group;
x and y independently represent 0 or an integer ranging from 1 to 3,000 and the sum (x+y+z) is equal to an integer ranging from 7 to 3,000, preferentially ranging from 10 to 3,000; and an acrylic alkyl ester or methacrylic alkyl ester monomer with the formula (C3)

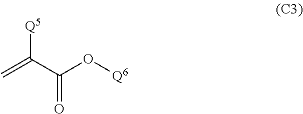

wherein
Q⁵ represents a hydrogen atom or a methyl group;
Q⁶ represents an either linear or branched C₁-C₂₆ alkyl group.

Preferentially, the alkyl methacrylate polymer is used in an amount of 0.1 to 15% by weight with respect to the total weight of the lubricating composition.

The base oil used in the lubricating compositions of the invention can be oils of mineral or synthetic origin belonging to groups I to V according to the classes defined by the API classification (or the equivalents thereof according to the ATIEL classification (Table 1) or the mixtures thereof.

TABLE 1

| | Concentration of | | |
|---|---|---|---|
| | saturated | Sulfur | Viscosity index |
| | substances | concentration | (VI) |
| Group I | <90% | >0.03% | 80 ≤ VI < 120 |
| Mineral oils | | | |
| Group II | ≥90% | ≤0.03% | 80 ≤ VI < 120 |
| Hydrocracked oils | | | |
| Group III | ≥90% | ≤0.03% | ≥120 |
| Hydro-isomerized | | | |
| oils | | | |

| | |
|---|---|
| Group IV | Polyalphaolefines (PAO) |
| Group V | Esters and other bases not included in groups I to IV |

The mineral base oils of the invention include any type of base oil obtained by atmospheric distillation and vacuum distillation of crude oil, followed by refining operations such as solvent extraction, deasphalting, solvent dewaxing, hydrotreatment, hydrocracking, hydroisomerization and hydrofinishing.

Mixtures of synthetic and mineral oils can also be used.

The base oils of the lubricating compositions according to the invention can be further chosen from synthetic oils, such as certain esters of carboxylic acids and alcohols, and polyalphaolefins. The polyalphaolefins used as base oil are e.g. obtained from monomers comprising from 4 to 32 carbon atoms, e.g. from octene or decene, and for which the viscosity at 100° C. is comprised between 1.5 and 15 mm²·s⁻¹ as per the ASTM D445 standard. The mean molar mass thereof is generally comprised between 250 and 3,000 as per the standard ASTM D5296.

The lubricating composition according to the invention can comprise at least 50% by weight of base oil with respect to the total weight of the composition. More advantageously, the lubricating composition according to the invention comprises at least 60% by weight, or even at least 70% by weight, of base oils with respect to the total weight of the lubricating composition. More preferentially, the lubricating composition according to the invention comprises from 75 to 97% by weight of base oils with respect to the total weight of the composition.

The composition of the invention can further comprise at least one additive.

Many additives can be used in the lubricating compositions according to the invention.

The preferred additives for the lubricating composition according to the invention are chosen from detergent additives, friction modifying additives different from the molybdenum compounds defined above, extreme pressure additives, dispersants, pour-point activators, antifoaming agents, thickeners and mixtures thereof.

Preferentially, the lubricating compositions according to the invention comprise at least one extreme pressure additive, or a mixture.

Anti-wear additives and extreme pressure additives protect against surface friction by forming a protective film adsorbed on the surfaces.

There is a wide variety of anti-wear additives. Preferentially, for the lubricating compositions of the invention, the anti-wear additives are chosen from additives comprising phosphorus and sulfur, such as metal alkylthiophosphates, in particular zinc alkylthiophosphate, and more precisely zinc dialkyldithiophosphate or ZnDTP. Preferred compounds have the formula Zn((SP(S)(OR)(OR′))2, wherein R and R′—either identical or different—independently represents an alkyl group, preferentially an alkyl group comprising from 1 to 18 carbon atoms.

Amine phosphates are also anti-wear additives which can be used in the lubricating compositions of the invention. However, the phosphorus atoms provided by such additives can act as a poison in the catalytic systems of automobiles since same generate ash. Such effects can be minimized by substituting part of the amine phosphates with non-phosphorus additives, such as polysulfides, in particular sulfur-containing olefins.

Advantageously, the lubricating compositions according to the invention can comprise from 0.01 to 6% by weight, preferentially from 0.05 to 4% by weight, more preferentially from 0.1 to 2% by weight with respect to the total weight of lubricating composition, anti-wear additives and extreme pressure additives.

Advantageously, the lubricating compositions according to the invention comprise from 0.01 to 6% by weight, preferentially from 0.05 to 4% by weight, more preferentially from 0.1 to 2% by weight with respect to the total weight of lubricating composition, of anti-wear additives (or anti-wear compound).

Advantageously, the compositions according to the invention can comprise at least one friction modifying additive different from the molybdenum compounds of the invention. The friction modifying additives can in particular, be chosen from compounds providing metallic elements and ashless compounds. Compounds providing metal elements include complexes of transition metals such as Mo, Sb, Sn, Fe, Cu, Zn for which the ligands can be hydrocarbon compounds comprising oxygen, nitrogen, sulfur or phosphorus atoms. Ashless friction modifying additives are generally of organic origin or can be chosen from fatty acid and polyol monoesters, alkoxylated amines, alkoxylated fatty amines, fatty epoxides, fatty epoxide borates, fatty amines or glycerol acid esters. According to the invention, fatty compounds comprise at least one hydrocarbon group comprising from 10 to 24 carbon atoms.

Advantageously, the lubricating composition according to the invention can comprise from 0.01 to 2% by weight or from 0.01 to 5% by weight, preferentially from 0.1 to 1.5% by weight or from 0.1 to 2% by weight with respect to the total weight of the lubricating composition, a friction modifying additive different from the molybdenum compounds according to the invention.

Advantageously, the lubricating composition according to the invention can comprise at least one antioxidant additive.

Antioxidant additives generally delay the degradation of the lubricating composition. Such degradation is most often expressed by a deposit formation, by the presence of sludge or by an increase in the viscosity of the lubricating composition.

Antioxidant additives generally act as radical inhibitors or hydroperoxide destructor inhibitors. Commonly used antioxidants include phenolic antioxidants, amine antioxidants, antioxidants containing sulfur and phosphorus. Some of the antioxidants, e.g. antioxidants containing sulfur and phosphorus, can generate ash. The phenolic antioxidant additives can be ash free or in the form of neutral or basic metal salts. The antioxidant additives can in particular be chosen from sterically hindered phenols, sterically hindered phenol esters, sterically hindered phenols comprising a thioether bridge, diphenylamines, diphenylamines substituted with at least one C₁ to C₁₂ alkyl group, N,N′-dialkyl-aryl-diamines and mixtures thereof.

Preferentially, according to the invention, the sterically hindered phenols are chosen from compounds comprising a phenol group for which at least one of the carbon atoms in the vicinity of the carbon atom bearing the alcohol function is substituted by at least one C₁ to C₁₀ alkyl group, preferentially a C₁ to C₆ alkyl group, preferentially a C₄ alkyl group, preferentially a tert-butyl group.

Amine compounds are another class of antioxidant additives which can be used, optionally in combination with phenolic antioxidant additives. Examples of amine compounds are aromatic amines, e.g. aromatic amines with the formula NRaRbRc wherein Ra represents an aliphatic group or an optionally substituted aromatic group, Rb represents alan optionally substituted aromatic group, RC represents a hydrogen atom, an kyl group, an aryl group or group with the formula RdS(O)zRE wherein Rd represents an alkylene or alkenylene group, Re represents an alkyl group, an alkenyl group or an aryl group, and z represents 0, 1 or 2.

Alkyl phenols containing sulfur or the alkali or alkaline-earth metal salts thereof can also be used as antioxidant additives.

Other classes of antioxidant additives are compounds comprising copper, e.g. copper thio- or dithio-phosphate, copper salts and carboxylic acids, dithiocarbamates, sulfonates, phenates, copper acetylacetonates. Copper salts I and II, succinic acid salts or succinic anhydride salts can also be used.

The lubricating compositions according to the invention can further comprise any type of antioxidant known to a person skilled in the art.

Advantageously, the lubricating composition comprises at least one ash free antioxidant additive.

Further advantageously, the lubricating composition according to the invention comprises from 0.1 to 2% by weight with respect to the total weight of the composition, of at least one antioxidant additive.

The lubricating composition according to the invention can further comprise at least one detergent additive.

Detergent additives generally reduce the formation of deposits on the surface of metal parts, by dissolving oxidation and combustion by-products.

The detergent additives which can be used in the lubricating compositions according to the invention are generally known to a person skilled in the art. The detergent additives can be anionic compounds comprising a long lipophilic hydrocarbon chain and a hydrophobic head. The associated cation can be a metal cation of an alkali or alkaline earth metal.

The detergent additives are preferentially chosen from alkali metal or alkaline-earth metal salts of carboxylic acid, sulphonates, salicylates, naphthenates, as well as phenate salts. The alkali metals and alkaline earth metals are preferentially calcium, magnesium, sodium or barium.

Such metal salts generally include the metal in a stoichiometric or in an excess amount, i.e. in a concentration greater than the stoichiometric concentration. Same are then overbased detergents; the excess of metal involving the overbased nature of the detergent additive is generally in the form of an oil-insoluble metal salt, e.g. carbonate, hydroxide, oxalate, acetate, glutamate, preferentially carbonate.

Advantageously, the lubricating composition according to the invention can comprise from 0.5 to 8% or from 2 to 4% by weight of detergent additive overbased with respect to the total weight of the lubricating composition.

Further advantageously, the lubricating composition according to the invention can further comprise an additive which lowers the pour-point.

By slowing down the formation of paraffin crystals, the pour-point lowering additive generally improves the behavior of the lubricating composition under cold conditions, according to the invention.

Examples of additives lowering the pour-point include alkyl polymethacrylates, polyacrylates, polyarylamides, polyalkylphenols, polyalkylnaphthalene, alkyls polystyrenes.

Advantageously, the lubricating composition according to the invention can further comprise a dispersing agent.

The dispersing agents can be chosen from Mannich bases, succinimides and derivatives thereof.

Further advantageously, the lubricating composition according to the invention can comprise from 0.2 to 10% by weight of dispersing agent with respect to the total weight of lubricating composition.

Advantageously, the lubricating composition according to the invention can further comprise at least one other additional polymer improving the viscosity index. As an example of an additional polymer improving the viscosity index, hydrogenated or non-hydrogenated polymeric esters, homopolymers or copolymers of styrene or butadiene, and isoprene, polymethacrylates (PMA), can be cited. Further advantageously, the lubricating composition according to the invention can comprise from 1 to 15% by weight, with respect to the total weight of lubricating composition, of additive improving the viscosity index.

The lubricating composition according to the invention can further comprise at least one thickening agent.

The lubricating composition according to the invention can further comprise an antifoaming agent and a demulsifying agent.

Preferentially, the lubricating composition of the invention further comprises at least one anti-wear agent, in particular an agent containing zinc, in particular ZnDTP.

The present invention further relates to the use of an alkyl methacrylate polymer in an engine lubricating composition, so as to reduce particle emissions.

The present invention further relates to a method for reducing the emission of particles in an engine, preferentially a gas, gasoline, diesel or hybrid engine, comprising the use of a lubricating composition comprising a base oil and an alkyl methacrylate polymer.

The present invention further relates to a method for reducing the emission of particles in an engine, preferentially a gas, gasoline, diesel or hybrid engine, lubricated by a lubricating composition comprising the addition of an alkyl methacrylate polymer to said lubricating composition.

The alkyl methacrylate polymer, the particles, the base oil and the lubricating composition are as defined hereinabove.

The present invention covers all motor vehicles, in particular vehicles comprising a 2-stroke or 4-stroke engine, gasoline, diesel, hybrid or gas engines.

The present invention covers all motor vehicles, preferentially comprising at least one combustion engine, in particular heavy vehicles or light vehicles.

The present invention will now be described with the help of non-limiting examples.

### EXAMPLE 1: LUBRICATING COMPOSITIONS

The following lubricating compositions were prepared according to Table 2 below.

TABLE 2

| | Composition 1 | Composition 2 | | |
|---|---|---|---|---|
| | (according to | (according to | Composition 3 | Composition 4 |
| | the invention) | the invention) | (comparative) | (comparative) |
| | (in % with | (in % with | (in % with | (% with |
| | respect to | respect to | respect to | respect to |
| | the total | the total | the total | the total |
| | weight of the | weight of the | weight of the | weight of |
| | composition) | composition) | composition) | composition) |
| Additives package | 15.6 | 15.6 | 15.6 | 15.6 |
| Base oil | 84.2 | 81.4 | 83.6 | 83.7 |
| Star-shaped | 0 | 0 | 0.8 | 0.7 |
| hydrogenated | | | | |
| styrene/isoprene | | | | |
| copolymer | | | | |
| Alkyl methacrylate | 0.2 | 3.0 | 0 | 0 |
| polymer | | | | |

The characteristics of the lubricating compositions are collated in Table 3 below:

TABLE 3

| | Composition 1 | Composition 2 | | |
|---|---|---|---|---|
| | (according to | (according to | Composition 3 | Composition 4 |
| | the invention) | the invention) | (comparative) | (comparative) |
| KV 40° C. | 31.79 | 24.89 | 28.55 | 29.1 |
| ASTM D445-97 | | | | |
| (mm²/s) | | | | |
| KV 100° C. | 6.254 | 5.837 | 5.894 | 6.038 |
| ASTM D445-97 | | | | |
| (mm²/s) | | | | |
| HTHS 150° C. | 2.13 | 2.07 | 2.06 | 2.12 |
| CEC L-036-90 or | | | | |
| ASTM D4683 | | | | |
| CCS −35° C. | 5531 | 1804 | 4177 | 3941 |
| ASTM D 5293 | | | | |
| Noack | 12.7% | 11.7% | 15.0% | 12.0% |
| ASTM D5800 or | | | | |
| CEC L-040-93 | | | | |

### EXAMPLE 2: MEASUREMENT OF THE NUMBER OF EMITTED PARTICLES

The compositions of example 1 were subject to the WLTC test and the quantity of particles per kilometer traveled with a size less than or equal to 23 nm emitted at the end of each cycle, was measured.

The engine tests were carried out on turbocharged straight-four engines. The tests were carried out at the same starting temperature of the engine. All other test bench conditions were kept constant as well. Sampling for the exhaust gas measurements was carried out from raw exhaust gases ahead from the exhaust system but after the treatment systems. Thus, the effects observed are indeed due solely to the use of the lubricating composition and thus to the use of the hydrogenated styrene-diene polymer and not to any other criterion such as the presence of a driver, the weight of the vehicle, the temperature, the relative humidity, etc.

The particle size distribution was measured in parallel by a Cambustion differential mobility spectrometer (DMS500). Same uses a high voltage discharge for charging every particle proportionally to the surface area thereof. The charged particles are introduced into a classification section with a strong radial electric field. Such field causes particles to drift through a flow inside a column, toward the electrometer detectors. The particles are detected at different distances in the column, depending on the aerodynamic resistance/charge ratio thereof. The outputs of the 22 electrometers are processed in real-time at 10 Hz, so as to provide spectral data and other measurements.

TABLE 4

| | Composition 1 | Composition 2 | | |
|---|---|---|---|---|
| | (according to | (according to | Composition 3 | Composition 4 |
| | the invention) | the invention) | (comparative) | (comparative) |
| | (number of | (number of | (number of | (number of |
| | particles with | particles with | particles with | particles with |
| | size less than | size less than | size less than | size less than |
| | or equal to | or equal to | or equal to | or equal to |
| | 23 nm) | 23 nm) | 23 nm) | 23 nm) |
| Urban cycle | 3.37E+10 | 3.93E+10 | 5.17E+10 | 5.15E+10 |
| Peri-urban | 2.88E+10 | 3.87E+10 | 4.43E+10 | 5.36E+10 |
| cycle | | | | |
| Road cycle | 1.15E+10 | 1.74E+10 | 1.93E+10 | 2.08E+10 |
| Freeway cycle | 1.64E+10 | 1.42E+10 | 1.40E+10 | 1.16E+10 |
| WLTC whole | 1.970E+10 | 2.3562E+10 | 2.6904E+10 | 2.8380E+10 |
| cycle (average | | | | |
| weighted by | | | | |
| the distance of | | | | |
| every phase) | | | | |

The results showed that the addition of an alkyl methacrylate polymer in a lubricating composition reduces the quantity—released from the exhaust—of particles with a size less than or equal to 23 nm.

1. A method for reducing the emission of particles in an engine said method comprising the use of a lubricating composition comprising a base oil and at least one alkyl methacrylate polymer.

2. The method according to claim 1, wherein the alkyl methacrylate polymer is a comb polymer, the pendant chains of which comprise at least 50 carbon atoms, said alkyl methacrylate polymer being chosen from copolymers of at least one polyolefin and at least one poly(alkyl)methacrylate; copolymers of at least one polyolefin and at least one poly(alkyl)acrylate.

3. The method according to claim 1, wherein the alkyl methacrylate polymer is a comb polymer the pendant chains of which are obtained by polymerization or copolymerization of olefins.

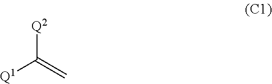

4. The method according to claim 1, wherein the alkyl methacrylate polymer is prepared by copolymerization: [symbol]
of an olefinic monomer with the formula (C2) 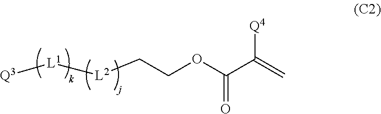
wherein
Q³ represents an either linear or branched C₂-C₈-alkyl group; a C₃-C₈-cycloalkyl group; a C₆-C₁₀-aryl group;
Q⁴ represents a hydrogen atom or a methyl group;
L¹ represents a 1,4-addition residue of butadiene; a 1,4-addition residue of butadiene substituted with at least one C₁-C₆ alkyl group; a vinyl addition residue of styrene; a vinyl addition residue of styrene substituted with at least one C₁-C₆-alkyl group;
L² represents a vinyl addition residue of butadiene; a vinyl addition residue of butadiene substituted with a C₁-C₆-alkyl group; a vinyl addition residue of styrene; a vinyl addition residue to styrene substituted with at least one C₁-C₆-alkyl group;
k and j independently represent 0 or an integer ranging from 1 to 3.000, and the sum (k+j) is equal to an integer ranging from 7 to 3,000; and [symbol]
of an acrylic alkyl ester or methacrylic alkyl ester monomer of formula (C3) 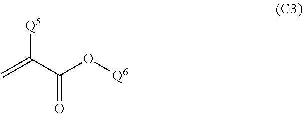
wherein:
Q⁵ represents a hydrogen atom or a methyl group
Q⁶ represents an either linear or branched C₁-C₂₆ alkyl group.

5. The method according to claim 1,
wherein the alkyl methacrylate polymer is prepared by copolymerization: [symbol]
of an olefinic monomer with the formula (C4) 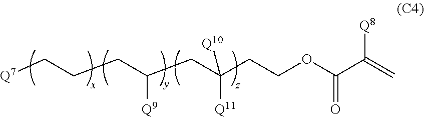
wherein:
Q⁷ represents a C₁-C₆-alkyl group; a C₆-aryl group;
Q⁸ represents a hydrogen atom or a methyl group;
Q⁹, Q¹⁰ and Q¹¹ independently represent a hydrogen atom or a C₁-C₁₈-alkyl group;
x, y and z independently represent 0 or an integer ranging from 1 to 3,000 and the sum (x+y+z) is equal to an integer ranging from 7 to 3,000; and [symbol]
of an acrylic alkyl ester or methacrylic alkyl ester monomer with the formula (C3) 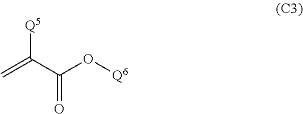
wherein:
Q⁵ represents a hydrogen atom or a methyl group;
Q⁶ represents an either linear or branched C₁-C₂-alkyl group.

6. The method according to any of claim 1,
wherein the alkyl methacrylate polymer is used in an amount of 0.1 to 15% by weight with respect to the total weight of the lubricating composition.

7. A method for reducing the emission of particles in an engine lubricated by a lubricating composition, said method comprising the addition of an alkyl methacrylate polymer to said lubricating composition.

8. The method according to claim 1, wherein the particles have a size less than or equal to 23 nm.

9. The method according to claim 1, wherein the reduction of particle emissions relates to urban, peri-urban and road-type cycles as defined by the WLTC and/or the whole WLTC.

10. The method according to claim 3, wherein the pendant chains of the comb polymer are obtained by polymerization or copolymnerization of olefins comprising from 8 to 17 carbon atoms and chosen from styrenes, substituted styrenes, butadiene with 1,4-addition, butadiene with 1,2-addition, compounds of formula (C₁) 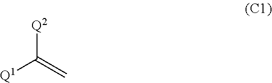
wherein Q¹ and Q² independently represent a hydrogen atom or a C₁-C₁₈-alkyl group.
